(19) United States
(12) Patent Application Publication
(10) Pub. No.: US 2009/0033480 A1
(43) Pub. Date: Feb. 5, 2009

(54) TIRE INFORMATION MONITORING SYSTEM AND TIRE INFORMATION TRANSMITTER

(76) Inventor: Takeshi Tanemura, Miyagi-ken (JP)

Correspondence Address: BRINKS HOFER GILSON & LIONE, P.O. BOX 10395, CHICAGO, IL, 60610, US

(21) Appl. No.: 12/174,891

(22) Filed: Jul. 17, 2008

(30) Foreign Application Priority Data
Aug. 3, 2007 (JP) 2007-202657

(51) Int. Cl. B60C 23/00

(52) U.S. Cl. 340/447

(57) ABSTRACT

A tire information monitoring system composed of a tire information transmitter mounted on tires and a vehicle-side device installed in a vehicle body is provided. The tire information transmitter comprises: an antenna; a sensor circuit configured as a resonance circuit; a transceiver circuit that is connected between the antenna and the sensor circuit, the transceiver circuit extracting an excitation signal for exciting the resonance circuit from a carrier wave signal received through the antenna to input the extracted excitation signal to the sensor circuit, and carrying a resonance signal generated in the sensor circuit in the carrier wave signal to wirelessly transmit the carrier wave signal through the antenna; and a correction data transmission circuit that stores therein correction data for correcting tire information measured by the sensor circuit in accordance with inherent characteristics of the sensor circuit, the correction data transmission circuit modulating the carrier wave signal received through the antenna with the correction data and wirelessly transmitting the modulated carrier wave signal through the antenna.

### RELATED APPLICATIONS

This application claims the benefit of priority under 35 U.S.C. §119 to Japanese Patent Application No. 2007-202657 filed Aug. 3, 2007, the contents of which are hereby incorporated by reference in their entirety.

### BACKGROUND OF THE DISCLOSURE

1. Field of the Disclosure

The present disclosure relates to a tire information monitoring system that transmits the internal tire information from a tire information transmitter provided at a tire side to a vehicle-side device provided at a vehicle side.

2. Description of the Related Art

As a device for monitoring pressure loss of pneumatic tires, a tire pressure monitoring system (TPMS) is known.

In the TPMS system, a tire-side transmitter (hereinafter, referred to as “transponder”) integrated with a tire valve is installed inside a tire, and air pressure and temperature are measured using a sensor circuit provided in the transponder. A vehicle-side device (hereinafter, referred to as “ECU”) transmits an RF signal to the transponder. Upon receipt of the RF signal, the transponder sends an RF signal containing tire information such as air pressure and temperature of a tire to the ECU. Then, the ECU extracts the tire information such as the air pressure and temperature of the tire from the RF signal to thereby monitor the tire state (see, Patent Document 1: U.S. Pat. No. 6,378,360B1(corresponding to JP-B-2000-517073)).

FIG. 8 is a diagram showing the construction of the TPMS system. The TPMS system is composed of a transponder 10 installed at the tire side and an ECU 20 installed distant from the tire. The transponder 10 is composed of a transceiver portion that includes an antenna 11, an antenna matching circuit 12, and a mixer circuit 13, and a sensor circuit portion that includes a temperature sensor circuit 14 and a pressure sensor circuit 15. A resonance frequency f1 of the temperature sensor circuit 14 is different from a resonance frequency f2 of the pressure sensor circuit 15, and a carrier wave signal f0 including an excitation signal (frequency: f1 or f2) is wirelessly transmitted from the ECU 20. The carrier wave signal received through the antenna 11 is filtered in the mixer circuit 13, whereby the excitation signal (f1 or f2) filtered from the carrier frequency f0 excites a crystal oscillator 16 of the temperature sensor circuit 14 or a crystal oscillator 17 of the pressure sensor circuit 15.

The temperature sensor circuit 14 resonates at a frequency (near f1) corresponding to the tire temperature. The resonance signal containing the tire temperature information is mixed with the carrier wave signal in the mixer circuit 13 and is then wirelessly transmitted through the antenna 11. In addition, in the pressure sensor circuit 15, a resonance circuit of a crystal oscillator 17 and a pressure sensor 18 formed of a capacitor of which the capacitance varies with the tire pressure is constructed, and the pressure sensor circuit 15 resonates at a frequency (near f2) corresponding to the tire pressure. The resonance signal containing the tire pressure information is mixed with the carrier wave signal in the mixer circuit 13 and is then wirelessly transmitted through the antenna 11.

The ECU 20 is composed of an antenna 21, a wireless circuit portion 22, a control portion 23, and a power supply 24, and is connected to an external device 25 such as a display device that delivers the tire information representing to a driver. The wireless circuit portion 22 modulates the carrier wave signal with frequencies f1 and f2 upon receipt of instructions from the control portion 23 to wirelessly transmit the modulated carrier wave signal and extracts the tire information such as the tire pressure and temperature from the RF signal received through the antenna 21 to deliver the tire information to the control portion 23. Then, the control portion 23 monitors the tire state from the tire information such as the tire pressure and temperature.

The temperature sensor circuit 14 and the pressure sensor circuit 15 have provided therein trimming capacitors 19a and 19b, respectively. Although the crystal oscillators 16 and 17 show their specification characteristics in a single body state, the apparent characteristics may change when actually mounted on a circuit. Therefore, the trimming capacitors 19a and 19b are used to perform adjustment of the crystal oscillators 16 and 17 in the mounted state so as to provide desired characteristics (resonance frequency).

However, the components (the crystal oscillators 16 and 17 and the pressure sensor 18) of the temperature sensor circuit 14 and the pressure sensor circuit 15 show mismatch in their characteristics within the operation range of the TPMS system. Using components having mismatched characteristics may lead to inability to obtain high-precision, temperature and pressure measurement results. In the past, in order to suppress the mismatch in the characteristics between components, components with well-matched characteristics were chosen with high precision; therefore, the component is pricey, which leads to increase in the overall system cost.

In addition, the trimming operation has to be performed at two locations (the trimming capacitors 19a and 19b) for one transponder. Therefore, the adjustment work required much time, deteriorating the workability.

### SUMMARY OF THE DISCLOSURE

The present disclosure provides a tire information transmitter that is mounted on tires and wirelessly transmits tire information to a vehicle-side device. The tire information transmitter comprises an antenna; a sensor circuit configured as a resonance circuit; and a transceiver circuit that is connected between the antenna and the sensor circuit. The transceiver circuit extracts an excitation signal for exciting the resonance circuit from a carrier wave signal received through the antenna to input the extracted excitation signal to the sensor circuit, and carries a resonance signal generated in the sensor circuit in the carrier wave signal to wirelessly transmit the carrier wave signal through the antenna. A correction data transmission circuit stores therein correction data for correcting tire information measured by the sensor circuit in accordance with inherent characteristics of the sensor circuit. The correction data transmission circuit modulates the carrier wave signal received through the antenna with the correction data and wirelessly transmits the modulated carrier wave signal through the antenna.

The present disclosure also provides a tire information monitoring system composed of a tire information transmitter mounted on tires and a vehicle-side device installed in a vehicle body, wherein the tire information transmitter comprises: an antenna; a sensor circuit configured as a resonance circuit; and a transceiver circuit that is connected between the antenna and the sensor circuit. The transceiver circuit extracts an excitation signal for exciting the resonance circuit from a carrier wave signal received through the antenna to input the extracted excitation signal to the sensor circuit, and carries a resonance signal generated in the sensor circuit in the carrier wave signal to wirelessly transmit the carrier wave signal through the antenna. A correction data transmission circuit stores therein correction data for correcting tire information measured by the sensor circuit in accordance with inherent characteristics of the sensor circuit. The correction data transmission circuit modulates the carrier wave signal received through the antenna with the correction data and wirelessly transmits the modulated carrier wave signal through the antenna. The vehicle-side device wirelessly transmits a carrier wave signal that does not contain a frequency signal at which the resonance circuit resonates and receives the carrier wave signal modulated with the correction data in the correction data transmission circuit to thereby acquire the correction data. The vehicle-side device wirelessly transmits a carrier wave signal that contains an excitation signal for exciting the resonance circuit and receives a carrier wave signal carrying a resonance signal of the resonance circuit from the tire information transmitter to thereby calculate a measurement value of the sensor circuit using the resonance signal and the correction data.

As a result of using the tire information transmitter and the tire information monitoring system according to the present disclosure, it is possible to provide high-precision measurement results even when components having different characteristics are used in a sensor circuit and thus to achieve cost reduction thanks to a low component cost while reducing the number of trimming operations of a transponder and thus improving workability.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 is a functional block diagram of a transponder in a TPMS system according to a first embodiment of the present disclosure.

FIG. 2 is a circuit diagram of the transponder shown in FIG. 1.

FIG. 3 is a functional block diagram of an ECU in the TPMS system according to the first embodiment.

FIG. 4 is a diagram illustrating actual measurement data showing the temperature-frequency characteristics of the temperature sensor circuit.

FIG. 5 is a diagram illustrating actual measurement data showing the pressure-frequency characteristics of the pressure sensor circuit.

FIG. 6 is a diagram illustrating the operation timings of the TPMS system according to the first embodiment.

FIG. 7 is a functional block diagram of a transponder in a TPMS system according to a second embodiment of the present disclosure.

FIG. 8 is a diagram showing the construction of a conventional TPMS system.

### DESCRIPTION OF THE EMBODIMENTS

Exemplary embodiments may be better understood with reference to the drawings, but these examples are not intended to be of a limiting nature. Like numbered elements in the same or different drawings perform equivalent or corresponding functions. Hereinafter, a TPMS system composed of a transponder and an ECU according to embodiments of the present disclosure will be described in detail with reference to the accompanying drawing.

### First Embodiment

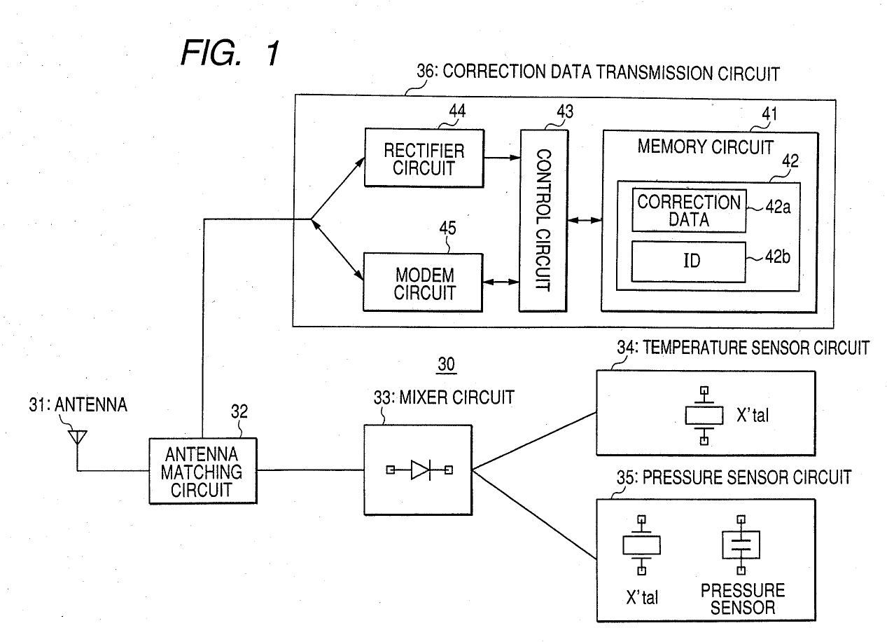

FIG. 1 is a functional block diagram of a transponder in a TPMS system according to a first embodiment of the present disclosure. As shown in FIG. 1, the transponder 30 is composed of a transceiver portion that includes an antenna 31, an antenna matching circuit 32, and a mixer circuit 33, a sensor circuit portion that includes a temperature sensor circuit 34 and a pressure sensor circuit 35, and a correction data transmission circuit 36 that stores therein the correction data of the sensor circuits.

The antenna matching circuit 32 is operable to perform impedance matching between an antenna 31 and a subsequent-stage circuit to thereby suppress a signal loss of a high-frequency signal. The mixer circuit 33 is a portion where an excitation signal of a predetermined frequency is extracted from the received carrier wave signal and is then supplied to the temperature sensor circuit 34 and the pressure sensor circuit 35, and where the resonance signal output from the temperature sensor circuit 34 and the pressure sensor circuit 35 is mixed with the carrier wave signal and the mixed signal is then transmitted through the antenna 31.

The correction data transmission circuit 36 has inherent information 42 stored in a memory circuit 41. The inherent information 42 includes correction data 42a of the temperature sensor circuit 34 and the pressure sensor circuit 35 that constitute the sensor circuit portion of the transponder 30 and identification data 42b of the tire having the transponder 30 installed therein. Write and read of the inherent information with respect to the memory circuit 41 is carried out by a control circuit 43. The electric power to the memory circuit 41 and the control circuit 43 is supplied from a rectifier circuit 44. The rectifier circuit 44 rectifies the carrier wave signal received through the antenna 31 to store electricity therein. A modem circuit 45 demodulates the inherent information 42 received through the antenna 31 and written in the memory circuit 41 and modulates the inherent information 42 read out of the memory circuit 41 and transmits the modulated information through the antenna 31. Description on a specific example of the correction data 42a stored in the memory circuit 41 will be provided later. In the correction data transmission circuit 36, there can be used a broader sense of RFID (radio frequency identification) tag including a non-contact type IC card, and other elements or devices other than the RFID tag as long as they have a function of storing the inherent information 42 and wireless transmitting the information according to the needs.

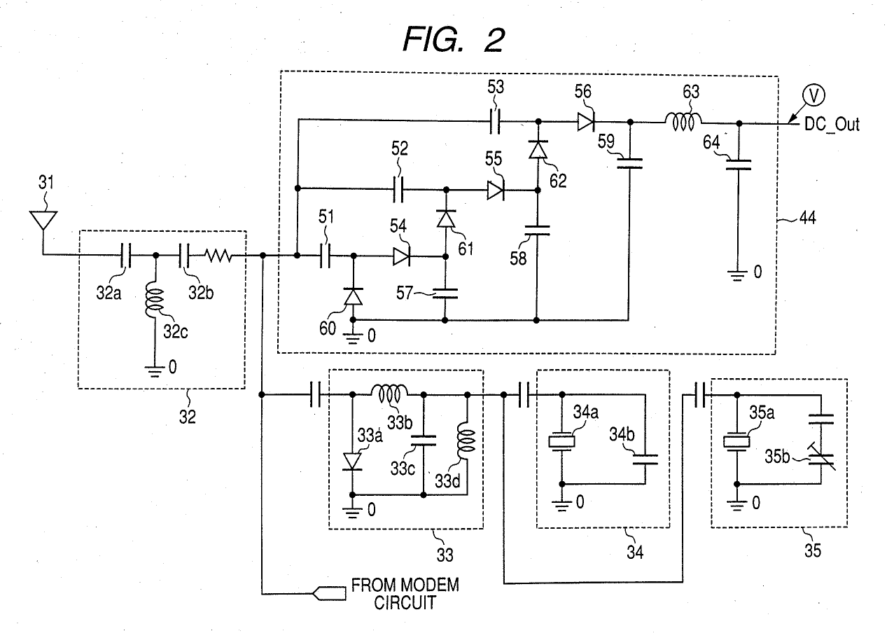

FIG. 2 is a circuit diagram of the transponder 30. In the drawing, as for the correction data transmission circuit 36, only the rectifier circuit 44 is illustrated. The antenna matching circuit 32 is composed of series capacitors 32a and 32b connected in series to the antenna 31 and a parallel inductor 32c connected in parallel to the antenna 31. Impedance is adjusted on a constant resistance circle by the series capacitors 32a and 32b, and by the parallel inductor 32c, the impedance is then adjusted to the center of the Smith chart on a constant inductance circle passing the center of the Smith chart. The mixer circuit 33 is composed of a diode 33a connected in parallel thereto, and a capacitor 33c and an inductor 33d that are connected in parallel to each other via an inductor 33b. The high-frequency carrier wave signal is dropped to the ground level by the diode 33a, and the excitation signal (f1, f2) used in modulation of the carrier wave signal is extracted by a filter formed by the serial inductor 33b, the parallel capacitor 33c, and the parallel inductor 33d. The temperature sensor circuit 34 is composed of a parallel circuit of a crystal oscillator 34a and a capacitor 34b. A resonance circuit is formed by the crystal oscillator 34a and the capacitor 34b, and the crystal oscillator 34a oscillates at the resonance frequency (near f1) of the resonance circuit. The excitation signal of frequency f1 extracted from the mixer circuit 33 excites the crystal oscillator 34a. The pressure sensor circuit 35 is composed of a parallel circuit of a crystal oscillator 35a and a piezoelectric capacitor 35b of which the capacitance varies with pressure. The excitation signal of frequency f2 extracted from the mixer circuit 33 excites the crystal oscillator 35a. The excitation signals generated in the temperature sensor circuit 34 and the pressure sensor circuit 35, of which the frequencies f1, f2 are slightly offset to resonance frequencies f1′, f2′ with temperature and pressure, are mixed with the carrier wave signal in the mixer circuit 33 and are then transmitted through the antenna 31.

The rectifier circuit 44 is constructed such that diodes 54 to 56 are connected via capacitors 51 to 53 in parallel to an output terminal of the antenna matching circuit 32 and charging capacitors 57 to 59 are connected in parallel to the diodes 54 to 56, respectively. In addition, diodes 60 to 62 are connected in the reverse direction between the ground and the respective anodes of the diodes 54 to 56. Also, the voltage charged to the parallelly connected capacitors 51 to 53 is supplied to each part of the correction data transmission circuit 36 via a smoothing circuit formed by an inductor 63 and a capacitor 64. In this example, the rectifier circuit 44 is implemented by a Cockcroft-Walton circuit, an example of a cascade rectifier circuit; however, other rectifier circuits may be used.

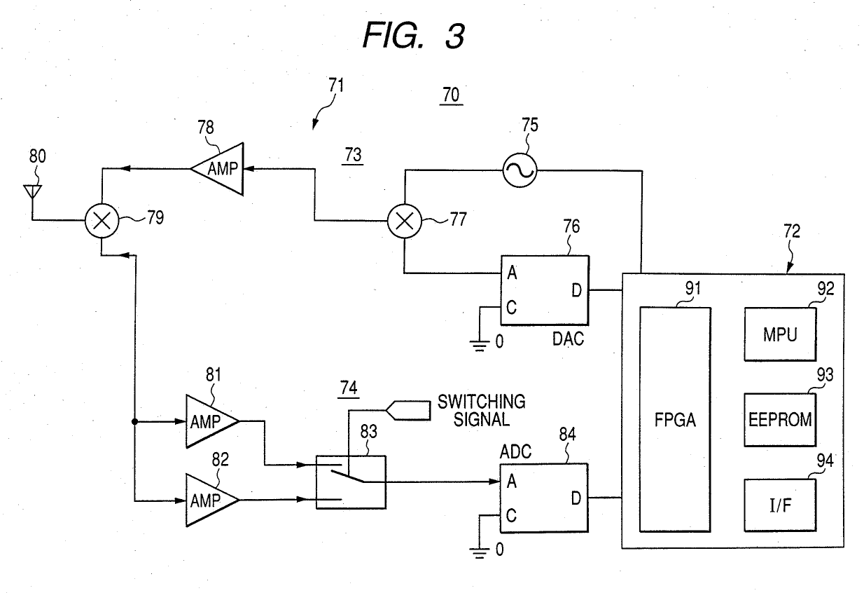

FIG. 3 is a functional block diagram of an ECU in the TPMS system according to the present embodiment. The ECU 70 is composed of a wireless circuit portion 71 for performing wireless communication with the transponder 30 and a control portion 72 for controlling the charging of the correction data transmission circuit 36 and acquisition of the tire information. The wireless circuit portion 71 is composed of a transmitter circuit 73 and a receiver circuit 74.

The transmitter circuit 73 includes an oscillator 75 that generates a carrier wave signal (for example, f0=0.45 GHz) according to the instructions from the control portion 72, a D/A converter 76 capable of changing the frequency of a modulation signal for modulating the carrier wave signal, a mixer circuit 77 for mixing the carrier wave signal with the modulation signal, an amplifier circuit 78 for power amplification the carrier wave signal output from the mixer circuit 77, and a mixer circuit 79 and an antenna 80 which are used in common with the receiver circuit 74. In this example, the D/A converter 76 generates, separately, a modulation signal of frequency f1, which becomes an excitation signal to the temperature sensor circuit 34, and a modulation signal of frequency f2, which becomes an excitation signal to the pressure sensor circuit 35.

The receiver circuit 74 includes an amplifier circuit 81 for power amplification of a resonance signal, which is received when the tire information is acquired, an amplifier circuit 82 for power amplification of a correction data signal, which is received when the correction data are received, a selection switch 83 for selection between the amplifier circuit 81 and the amplifier circuit 82 based on a switching signal from the control circuit 72, and an A/D converter 84 for A/D conversion of the resonance signal or the correction data signal received via the selection switch 83.

The control portion 72 includes an FPGA 91, an MPU 92, an EEPROM 93, and an I/F 94. In this example, the correction of the measurement data received from the transponder 30 is carried out in the FPGA 91. The MPU 92 generates a transmission trigger signal and changes the modulation frequency of the carrier wave signal at a predetermined timing described later to thereby output a switching signal to the selection switch 83. The I/F 94 is connected to an external device.

Next, the correction data stored in the memory circuit 41 of the transponder 30 will be described.

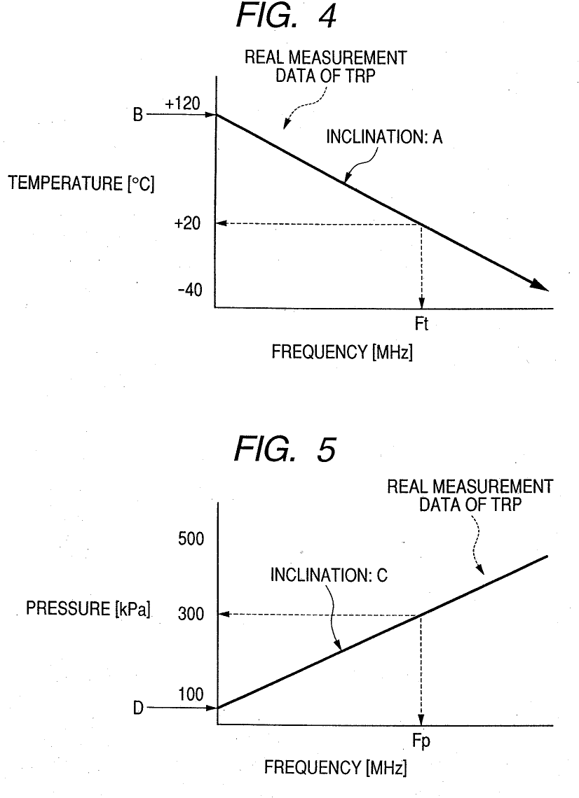

FIG. 4 shows the actual measurement data showing the temperature-frequency characteristics of the temperature sensor circuit 34 of the transponder 30. The frequency on the horizontal axis is the resonance frequency at which the crystal oscillator 34a oscillates. By knowing the temperature-frequency characteristics of the temperature sensor circuit 34, it is possible to calculate tire temperature data from the resonance frequency (f1′) information of the temperature sensor circuit 34 by the following formula.

Temperature=A*[resonance frequency (f1′)]+B (Formula 1)

In the present embodiment, as a parameter for defining the actual measurement data showing the temperature-frequency characteristics of the temperature sensor circuit 34, an inclination A and an offset B of the actual measurement data are used, and these parameters (inclination A and offset B) are stored as the correction data in the memory circuit 41.

For example, for each temperature sensor circuit 34, the resonance frequency (f1′) at which the crystal oscillator 34a oscillates is measured at multiple points of within an operation temperature range (from −40° C. to +120° C.). Then, the characteristic diagram shown in FIG. 4 is obtained from the actual measurement data measured at the multiple points, and the inclination A and the offset B of the actual measurement data are calculated.

FIG. 5 shows the actual measurement data showing the pressure-frequency characteristics of the pressure sensor circuit 35 of the transponder 30. The frequency on the horizontal axis is the resonance frequency at which the crystal oscillator 35a oscillates. By knowing the pressure-frequency characteristics of the pressure sensor circuit 35, it is possible to calculate tire pressure data from the resonance frequency (f2′) information of the pressure sensor circuit 35 by the following formula.

Pressure=C*[resonance frequency (f2′)]+D (Formula 2)

In the present embodiment, as a parameter for defining the actual measurement data showing the pressure-frequency characteristics of the pressure sensor circuit 35, an inclination C and an offset D of the actual measurement data are used, and these parameters (inclination C and offset D) are stored as the correction data in the memory circuit 41.

For example, for each pressure sensor circuit 35, the resonance frequency (f2′) at which the crystal oscillator 35a oscillates is measured at multiple points of within an operation temperature range (from −40° C. to +120° C.) and within an operation pressure range (from 100 kPa to 500 kPa). Then, the characteristic diagram shown in FIG. 5 is obtained from the actual measurement data measured at the multiple points, and the inclination C and the offset D of the actual measurement data are calculated. Moreover, the characteristic diagram shown in FIG. 5 is set for each temperature.

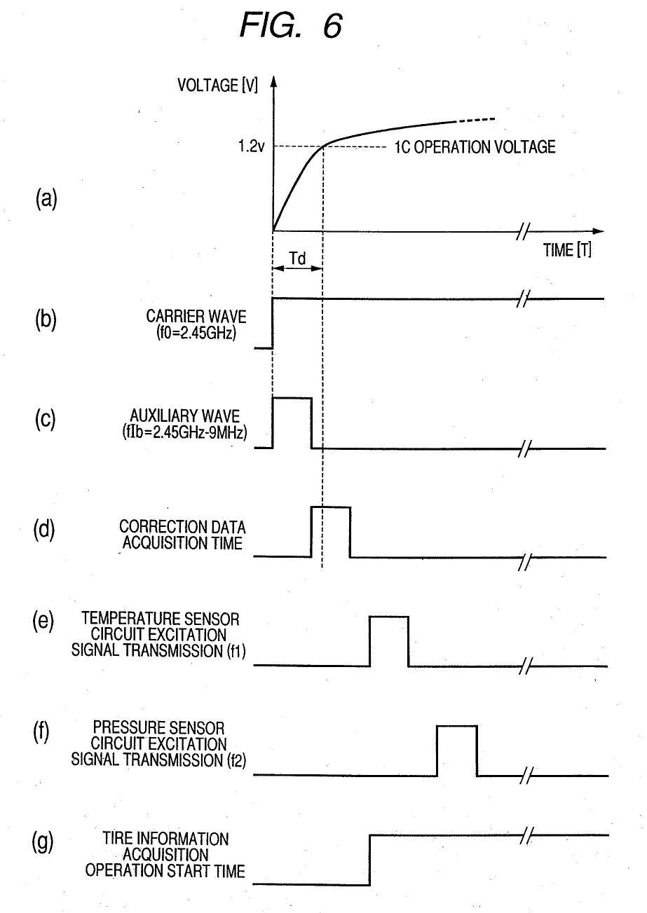

Next, the operation of the present embodiment having such a construction will be described with reference to FIG. 6.

FIG. 6 is a timing diagram illustrating the operation timings of the TPMS system according to the present embodiment. It will be assumed that the inherent information 42 is stored in the memory circuit 41 of the transponder 30.

First, prior to the acquisition of the tire information, the inherent information 42 stored in the memory circuit 41 of the transponder 30 is provided to the control portion 72 of the ECU 70. By referring to FIGS. 6(a) to 6(d), a series of operations from the electricity storage operation of the rectifier circuit 44 until the inherent information 42 is provided to the control portion 72 will be described.

FIG. 6(a) is a diagram showing a direct output voltage of the rectifier circuit 44. The correction data transmission circuit 36 starts its operation when the direct output voltage of the rectifier circuit 44 exceeds an IC operation voltage (for example, about 1.2 V). In addition, the rectifier circuit 44 is regulated such that the direct output voltage does not exceed 2 V.

The control portion 72 of the ECU 70 activates the oscillator 75 at the same time with the initial power input to start transmission of a carrier wave signal (f0=2.45 GHz) (see FIG. 6(b)). In the present embodiment, in order to shorten the time until the direct output voltage of the rectifier circuit 44 reaches a minimum operable voltage, an auxiliary wave signal (f1P) is also transmitted separate from the carrier wave signal (f0) (see FIG. 6(c)). For this reason, digital data for transmission of the auxiliary wave signal (f1P) are supplied to the D/A converter 76 in order to strengthen the transmission power. The frequency of the auxiliary wave signal (f1P) is selected as a frequency at which the sensor circuits 34 and 35 do not resonate. An analog signal of the auxiliary wave signal f1P is output from the D/A converter 76. The carrier wave signal f0 is modulated with the auxiliary wave signal f1P by the mixer circuit 77 and is transmitted through the antenna 80.

In the transponder 30, two wave signals of the carrier wave signal and the auxiliary wave signal are received through the antenna 31. The high-frequency reception signal of the auxiliary wave signal f1P and the carrier wave signal f0 output through the antenna 31 is input to the rectifier circuit 44 of the correction data transmission circuit 36 via the antenna matching circuit 32. In the rectifier circuit 44, the high-frequency reception signal is rectified by the above-mentioned Cockcroft-Walton circuit via multiple stages, with the result that the direct output voltage of the rectifier circuit 44 reaches the minimum operable voltage (1.2 V) after a predetermined period of time (Td). As a result, electricity is supplied to each part of the correction data transmission circuit 36 after the predetermined period of time (Td) from the start of operation.

The control portion 72 of the ECU 70 stops the transmission of the auxiliary wave signal f1P from the D/A converter 76 after a predetermined period of time from the start of operation, whereby the operation switches to an operation of receiving the inherent information 42 (correction data and tire identification information) transmitted from the transponder 30.

In the correction data transmission circuit 36, when the direct output voltage of the rectifier circuit 44 reaches the minimum operable voltage, the control circuit 43 reads the inherent information 42 out of the memory circuit 41 and inputs the information to the modem circuit 45. The modem circuit 45 modulates the carrier wave signal f0 based on the inherent information 42. For example, the carrier wave signal is modulated with a frequency (for example, with an offset of 32 kHz from the carrier wave signal f0) different from the resonance frequencies of the sensor circuits by the order of one digit, and the modulated carrier wave signal is transmitted to the antenna 31 side. As a result, the carrier wave signal containing the inherent information 42 is transmitted through the antenna 31 of the transponder 30 after the predetermined period of time (Td) from the start of operation.

The control portion 72 of the ECU 70 has the selection switch 83 switched to the amplifier circuit 82 side in order to receive the carrier wave signal containing the inherent information 42 transmitted from the transponder 30 (see FIG. 6(d)). The carrier wave signal received through the antenna 80 of the ECU 70 is input to the mixer circuit 79, where the modulated wave component (at the frequency having an offset of 32 kHz from the carrier wave f0) containing the inherent information 42 is extracted and is then subjected to power amplification in the amplifier circuit 82. The modulated wave component containing the inherent information 42 is input to the A/D converter 84 via the selection switch 83, converted to digital data, and input to the control portion 72.

The control portion 72 stores the correction data 42a included in the inherent information 42 in a predetermined storage area. Since the inherent information 42 is transmitted from the transponder 30 installed in each tire, the correction data 42a are stored for each tire. In this way, prior to the acquisition of the tire temperature data and the tire pressure data, the correction data 42a corresponding to individual characteristics of the sensor circuits (the temperature sensor circuit 34 and the pressure sensor circuit 35) are transmitted from the transponder 30 of each tire and are stored in the ECU 70.

Next, the control portion 72 proceeds to an operation of acquiring and monitoring the tire temperature data and the tire pressure data from the transponder 30. First, the ECU 70 transmits an excitation signal (near frequency f1) for the temperature sensor circuit 34. In order for this to work, the control portion 72 outputs modulation digital data corresponding to the excitation signal (f1) to the D/A converter 76. The excitation signal (f1) obtained by D/A converting the modulation digital data in the D/A converter 76 is mixed with the carrier wave signal (f0) in the mixer circuit 77, subjected to power amplification in the amplifier circuit 78, and then transmitted through the antenna 80 (see FIG. 6(e)).

At this time, the control portion 72 outputs a switching signal for switching the selection switch 83 to switch to the amplifier circuit 81 at the same time with the start of transmission of the excitation signal (f1) (see FIG. 6(g)). With this switching, after the start of the acquisition operation of the tire information, the modulation signal component including the temperature data or the pressure data received through the antenna 80 is received via the amplifier circuit 81.

In the transponder 30, upon receipt of the carrier wave signal f0 through the antenna 31 modulated with the excitation signal (f1), the signal component centered at the excitation signal (f1) is extracted by the mixer circuit 33 and is supplied to the sensor circuits. The temperature sensor circuit 34 has its resonance frequency set to the same frequency as the excitation signal (f1) in its initial setting. Since the resonance frequency varies with the tire temperature, the temperature sensor circuit 34 having the excitation signal (f1) introduced therein resonates at a resonance frequency (f1′) corresponding to the tire temperature (that is, the crystal oscillator 34a oscillates). When the transmission of the excitation signal by the ECU 70 stops, the resonance signal (f1′) modulates, via the mixer circuit 33, the carrier wave signal f0 that is applied to the input terminal of the mixer circuit 33. Therefore, the carrier wave signal f0 modulated with the resonance signal (f1′) is transmitted through the antenna 31. At this time, since the pressure sensor circuit 35 has its resonance frequency set to a frequency offset by 1 MHz or more from the central frequency of the excitation frequency (f1), the pressure sensor circuit 35 is not excited at the excitation signal (f1) for the temperature sensor circuit.

In the ECU 70, the carrier wave signal f0 modulated with the resonance signal (f1′) is received, and the resonance signal component (f1′), which is the modulation signal component of the carrier wave signal f0, is extracted by the mixer circuit 79. The resonance signal component (f1′) is amplified by the amplifier circuit 81, and is thereafter received via the selection switch 83 in the control portion 72 in a digital data form. In the control portion 72, it can be recognized from the presently transmitted excitation signal (f1) that the presently received resonance signal component (f1′) is the resonance frequency of the temperature sensor circuit 34. In the FPGA 91, the tire temperature is calculated by substituting the resonance frequency (f1′) in the formula 1 and using the previously received correction data (inclination A and offset B) of the temperature sensor circuit 34 for the corresponding tire. The calculated tire temperature is used for measurement of the tire pressure.

The ECU 70 measures the tire temperature of a specific tire and then measures the tire pressure of the specific tire. The control portion 72 starts transmission of the excitation signal (near frequency f2) to the pressure sensor circuit 35. In order for this to work, the control portion 72 outputs modulation digital data corresponding to the excitation signal (f2) to the D/A converter 76. The excitation signal (f2) obtained by D/A converting the modulation digital data in the D/A converter 76 is mixed with the carrier wave signal (f0) in the mixer circuit 77, subjected to power amplification in the amplifier circuit 78, and then transmitted through the antenna 80 (see FIG. 6(f)).

In the transponder 30, upon receipt of the carrier wave signal f0 through the antenna 31 modulated with the excitation signal (f2), the excitation signal component centered at the excitation signal (f2) is extracted by the mixer circuit 33 and is supplied to the sensor circuits. The pressure sensor circuit 35 has its resonance frequency set to the same frequency as the excitation signal (f2) in its initial setting. Since the resonance frequency varies with the tire temperature and pressure, the pressure sensor circuit 35 having the excitation signal (f2) introduced therein resonates at a resonance frequency (f2′) corresponding to the tire temperature (that is, the crystal oscillator 35a oscillates). When the transmission of the excitation signal by the ECU 70 stops, the resonance signal (f2′) modulates, via the mixer circuit 33, the carrier wave signal f0 that is applied to the input terminal of the mixer circuit 33. Therefore, the carrier wave signal f0 modulated with the resonance signal (f2′) is transmitted through the antenna 31. At this time, since the temperature sensor circuit 34 has its resonance frequency set to a frequency offset by 1 MHz or more from the central frequency of the excitation frequency (f2), the temperature sensor circuit 34 is not excited at the excitation signal (f2) for the pressure sensor circuit.

In the ECU 70, the carrier wave signal f0 modulated with the resonance signal (f2′) is received, and the resonance signal component (f2′), which is the modulation signal component of the carrier wave signal f0, is extracted by the mixer circuit 79. The resonance signal component (f2′) is amplified by the amplifier circuit 81, and is thereafter received via the selection switch 83 in the control portion 72 in a digital data form. In the control portion 72, it can be recognized from the presently transmitted excitation signal (f2) that the presently received resonance signal component (f2′) is the resonance frequency of the pressure sensor circuit 35. In the FPGA 91, the correction data in the vicinity of the present tire temperature are selected from among the previously received correction data of the pressure sensor circuit 35 for the corresponding tire. The present tire temperature may be the tire temperature measured immediately previously. Then, the tire pressure is calculated by substituting the resonance frequency (f2′) in the formula 2 and using the correction data (inclination C and offset D) corresponding to the present tire temperature.

In the embodiment described above, the frequencies of the excitation signals for the measurement of the tire temperature and the tire pressure were described as being constant. However, in practical cases, there is used a method in which the frequency of the excitation signal is sequentially varied by 10 kHz and is repeatedly transmitted. Therefore, even when the resonance frequency of the temperature sensor circuit and the pressure sensor circuit does not vary in a uniform manner due to the difference in the characteristics of the components of the transponder, it is possible to cause the temperature sensor circuit and the pressure sensor circuit to appropriately resonate.

In this way, in the present embodiment, the correction data 42a corresponding to the actual measurement data showing the temperature-resonance frequency characteristics of the temperature sensor circuit 34 and the pressure-resonance frequency characteristics of the pressure sensor circuit 35 are calculated and stored in the memory circuit 41 of the transponder 30. Thereafter, the correction data 42a are transmitted from the transponder 30 to the ECU 70 before the acquisition operation of the tire information is started. And, during the tire information acquisition operation, the tire temperature and the tire pressure are calculated using the correction data 42a. Therefore, even when components having well-matched characteristics are chosen for use in the temperature sensor circuit 34 and the pressure sensor circuit 35 but components having mismatched characteristics are used for the sensor circuits 34 and 35, it is possible to measure the tire temperature and the tire pressure with high precision based on the formulas 1 and 2. Accordingly, it is possible to decrease the component cost and to thus decrease the overall system cost.

In addition, although in the conventional circuit, the resonance frequency is set by adjusting the trimming capacitors 19a and 19b provided in the temperature sensor circuit 34 and the pressure sensor circuit 35, in the present embodiment, the correction data 42a are calculated from the actual measurement data showing the temperature-resonance frequency characteristics of the temperature sensor circuit 34 and the pressure-resonance frequency characteristics of the pressure sensor circuit 35. Therefore, it is possible to decrease the number of trimming operations by the trimming capacitors 19a and 19b, and to thus greatly improve the work efficiency.

Moreover, according to the present embodiment, the rectifier circuit 44 for rectifying the high-frequency reception signal of the carrier wave signal received through the antenna 31 to thereby store electricity therein is provided in the transponder 30. Therefore, it is not necessary to operate the sensor circuits 34 and 35 and the correction data transmission circuit 36 in the battery-free state.

In the present embodiment described above, the electricity storage operation and the correction data acquisition operation of the correction data transmission circuit 36 were described as being carried out prior to the tire information acquisition operation. Such a method is advantageous because of its simple procedure since the correction data once acquired are stored in the EEPROM 93 of the control portion 72 and thus do not need to be acquired again in the activated state of the TPMS system. However, the present disclosure is not limited to this, the above-mentioned operations may be performed after the tire information is acquired, and alternatively, may be performed once every, or several, tire information acquisition operations.

### Second Embodiment

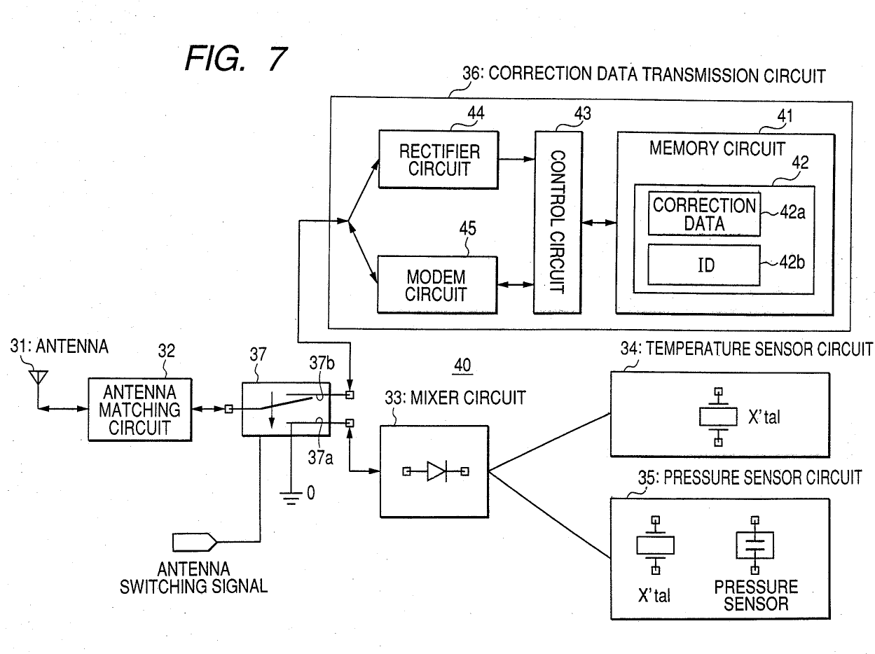

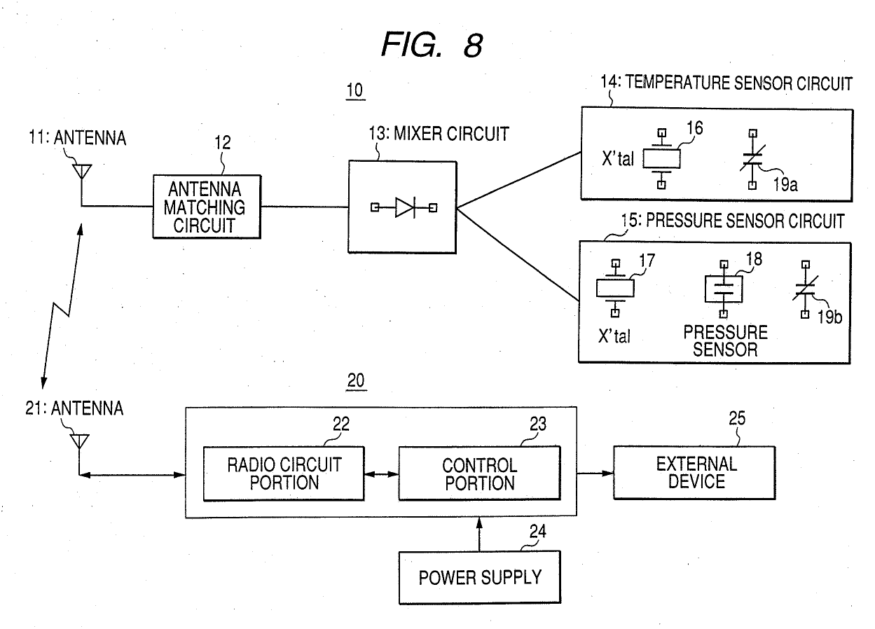

FIG. 7 is a functional block diagram of a transponder in a TPMS system according to a second embodiment of the present disclosure. The same or similar parts as the transponder 30 shown in FIG. 1 will be denoted by the same reference numerals, and redundant descriptions thereof will be omitted. Moreover, the ECU-side construction and operation are the same as those of the first embodiment.

A transponder 40 of the present disclosure is constructed such that the sensor circuits including the mixer circuit 33 and the correction data transmission circuit 36 are selectively connected to the antenna matching circuit 32. An antenna selection switch 37 is connected to the output terminal of the antenna matching circuit 32 opposite to the antenna 31, and the input terminal of the mixer circuit 33 close to the sensor circuit side is connected to one selection terminal 37a of the antenna selection switch 37. In addition, the correction data transmission circuit 36 is connected to the other selection terminal 37b of the antenna selection switch 37. The antenna selection switch 37 is controlled such that the side at which the antenna 31 is connected is selected in accordance with the antenna switching signal from the control circuit 43.

In the present disclosure, during the correction data acquisition period of time as shown in FIG. 6(d), the antenna 31 is connected to the correction data transmission circuit 36 via the selection terminal 37b, while during the tire information acquisition period of time as shown in FIG. 6(g), the antenna 31 is connected to the sensor circuit side via the selection terminal 37a. Other constructions are the same as those of the transponder 30 of the first embodiment.

Next, the operation of the present embodiment having such a construction will be described.

The antenna selection switch 37 is connected to the selection terminal 37b in the initial state. Therefore, in the transponder 40, when the operation of the ECU 70 starts, two wave signals of the carrier wave signal f0 and the auxiliary wave signal f1P are received through the antenna 31. However, since the sensor circuit side is separated by the antenna selection switch 37, the power is not distributed to the sensor circuit side but is entirely distributed to the correction data transmission circuit 36. Although a part of the high-frequency reception signal which is introduced to the correction data transmission circuit 36 is branched into the modem 45 side, this power loss is sufficiently small compared when it is branched into the sensor circuit side.

Meanwhile, the carrier wave signal f0 modulated with the inherent information 42 output from the modem circuit 45 of the correction data transmission circuit 36 is transmitted through the antenna 31 via the selection terminal 37b of the antenna selection switch 37. At this time, since the sensor circuit side is separated from the antenna selection switch 37, the power is not branched into the sensor circuit side. Therefore, it is possible to prevent unnecessary power loss during transmission, which may caused when the power is branched into the sensor circuit side.

Upon completion of the transmission of the inherent information 42, the control circuit 43 causes the antenna selection switch 37 to be switched to the selection terminal 37a to thereby connect the antenna 31 to the sensor circuit side and separate the correction data transmission circuit 36 from the connection. Thereafter, during the tire information acquisition operation, the antenna selection switch 37 maintains its switching state to the selection terminal 37a and holds the state where the correction data transmission circuit 36 is separated from the connection.

The carrier wave signal f0 modulated with the excitation signal (f1 or f2) is received from the ECU 70 through the antenna 31 of the transponder 40; however, the high-frequency reception signal at that moment is input the mixer circuit 33 via the selection terminal 37a of the antenna selection switch 37. Since the correction data transmission circuit 36 is in the state wherein it is separated from the antenna 31, the high-frequency reception signal modulated with the excitation signal (f1 or f2) is not distributed to the correction data transmission circuit 36.

In addition, the modulation signal of the carrier wave signal f0 modulated with the resonance signal f1′ or f2′ generated from the temperature sensor circuit 34 or the pressure sensor circuit 35, which is excited by the excitation signal f1 or f2, is propagated to the antenna 31 via the selection terminal 37a of the antenna selection switch 37. Even in this case, since the correction data transmission circuit 36 is in the state wherein it is separated from the antenna 31, the power is not lost due to the distribution to the correction data transmission circuit 36.

In this way, according to the present embodiment, the modem circuit 45 of the correction data transmission circuit 36 or the mixer circuit 33 is selectively connected to the antenna 31 (including the antenna matching circuit 32) via the antenna selection switch 37. Therefore, it is possible to reduce the loss of the response power and the reception power in the transponder 40 and to thus extend the communication distance between the transponder 40 and the ECU 70.

In the description above, the modem circuit 45 is provided to the correction data transmission circuit 36, and the tire information 42 is received through the antenna 31 and recorded in the memory circuit 41. A modulation circuit may substitute the modem circuit 45 when the tire information 42 is recorded in the memory circuit 41 without intervention of such a radio communication.

Moreover, in the description above, the correction data 42a are stored such that the correction data of the temperature sensor circuit 34 are composed of an inclination A and an offset B, and that the correction data of the pressure sensor circuit 35 are composed of an inclination C, an offset D, and temperature. However, the component of the correction data is not limited to this. For example, the correction data may be managed in a lookup table form, and when the resonance frequency of the sensor circuit is input, a measurement value that is corrected in accordance with the inherent characteristics of the sensor circuit is output without the necessity of the calculation based on the formula 1 or 2.

In addition, the present disclosure can be applied to other purposes besides the TPMS system, and tire state information (for example, acceleration) besides the tire temperature or the tire pressure may be corrected in the manner described above.

The present disclosure can be applied to a TPMS system that monitors the temperature or pressure of pneumatic tires.

The terms and descriptions used herein are set forth by way of illustration only and are not meant as limitations. Those skilled in the art will recognize that many variations can be made to the details of the above-described embodiments without departing from the underlying principles of the disclosure. The scope of the disclosure should therefore be determined only by the following claims (and their equivalents) in which all terms are to be understood in their broadest reasonable sense unless otherwise indicated.

What is claimed is:

1. A tire information transmitter that is mounted on tires and wirelessly transmits tire information to a vehicle-side device, the tire information transmitter comprising:
an antenna;
a sensor circuit configured as a resonance circuit;
a transceiver circuit that is connected between the antenna and the sensor circuit, the transceiver circuit extracting an excitation signal for exciting the resonance circuit from a carrier wave signal received through the antenna to input the extracted excitation signal to the sensor circuit, and carrying a resonance signal generated in the sensor circuit in the carrier wave signal to wirelessly transmit the carrier wave signal through the antenna; and
a correction data transmission circuit that stores therein correction data for correcting tire information measured by the sensor circuit in accordance with inherent characteristics of the sensor circuit, the correction data transmission circuit modulating the carrier wave signal received through the antenna with the correction data and wirelessly transmitting the modulated carrier wave signal through the antenna.

2. The tire information transmitter according to claim 1, wherein the correction data transmission circuit comprises a rectifier circuit that rectifies a high-frequency reception signal output from the antenna through which the carrier wave signal is received to thereby output a direct output voltage.

3. The tire information transmitter according to claim 1, further comprising an antenna selection circuit for selectively connecting the transceiver circuit or the correction data transmission circuit to the antenna.

4. A vehicle-side device that is mounted on tires and that wirelessly communicates with a tire information transmitter having a sensor circuit configured as a resonance circuit to thereby acquire tire information,
wherein the vehicle-side device wirelessly transmits a carrier wave signal that does not contain a frequency signal at which the resonance circuit resonates and receives, from the tire information transmitter, correction data for correcting tire information measured by the sensor circuit in accordance with inherent characteristics of the sensor circuit, and
wherein the vehicle-side device wirelessly transmits a carrier wave signal that contains an excitation signal for exciting the resonance circuit and receives a carrier wave signal carrying a resonance signal of the resonance circuit from the tire information transmitter to thereby calculate a measurement value of the sensor circuit using the resonance signal and the correction data.

5. A tire information monitoring system composed of a tire information transmitter mounted on tires and a vehicle-side device installed in a vehicle body,
wherein the tire information transmitter comprises:
an antenna;
a sensor circuit configured as a resonance circuit;
a transceiver circuit that is connected between the antenna and the sensor circuit, the transceiver circuit extracting an excitation signal for exciting the resonance circuit from a carrier wave signal received through the antenna to input the extracted excitation signal to the sensor circuit, and carrying a resonance signal generated in the sensor circuit in the carrier wave signal to wirelessly transmit the carrier wave signal through the antenna; and
a correction data transmission circuit that stores therein correction data for correcting tire information measured by the sensor circuit in accordance with inherent characteristics of the sensor circuit, the correction data transmission circuit modulating the carrier wave signal received through the antenna with the correction data and wirelessly transmitting the modulated carrier wave signal through the antenna,
wherein the vehicle-side device wirelessly transmits a carrier wave signal that does not contain a frequency signal at which the resonance circuit resonates and receives the carrier wave signal modulated with the correction data in the correction data transmission circuit to thereby acquire the correction data, and
wherein the vehicle-side device wirelessly transmits a carrier wave signal that contains an excitation signal for exciting the resonance circuit and receives a carrier wave signal carrying a resonance signal of the resonance circuit from the tire information transmitter to thereby calculate a measurement value of the sensor circuit using the resonance signal and the correction data.
